(19) United States
(12) Patent Application Publication
(10) Pub. No.: US 2025/0074748 A1
(43) Pub. Date: Mar. 6, 2025

(54) Elevator Plate Assembly

(71) Applicant: Stiltz Limited, Kingswinford (GB)

(72) Inventors: Chris Westwood, Kingswinford (GB); Andrew Morrice, Kingswinford (GB)

(21) Appl. No.: 18/458,098

(22) Filed: Aug. 29, 2023

(51) Int. Cl. B66B 13/28; B66B 1/34

(52) U.S. Cl. CPC B66B 13/28; B66B 1/3461

(57) ABSTRACT

An elevator plate assembly for use with an elevator system including an elevator car configured to move between levels of a building along a pathway, the assembly including: a plate configured to be positioned to cover an aperture defined by a floor of the building and to be carried by the elevator car as the elevator car travels along the pathway through the aperture defined by the floor of the building; and a sensor system configured to be communicatively coupled to a control system of the elevator system, the sensor system including a pressure sensitive device coupled to the plate, the pressure sensitive device being configured to detect the presence on an obstruction on the plate by detecting a force applied to the pressure sensitive device which is greater than a threshold force, such that, on detection of the presence of an obstruction by the pressure sensitive device, the sensor system is configured to send an alert to the elevator control system.

### FIELD

Embodiments relate to elevator plate assemblies for use in elevator systems.

### BACKGROUND

Elevator systems include elevators with relatively high weight capacities for use in office buildings, retail environments, and apartment buildings. These are typically relatively expensive and include an elevator shaft or hoistway through which the elevator car travels (often between a large number of different levels). Such elevator systems are typically cable operated and include a machine room at the top of the elevator shaft which includes the hoist machinery which drives movement of the elevator car through the elevator shaft.

Elevator systems in single occupancy dwelling domestic settings typically have lower weight and occupant capacities than elevator systems in office and retail settings, or multi-occupancy dwellings (such as apartments and high-rise accommodation). There is a growing market for elevator systems which have a lower weight and occupant capacity and require less infrastructure for their installation. Such elevator systems can be retrofitted into domestic settings, and may be installed to assist elderly and disabled people, or people with otherwise reduced mobility, to access different levels in a domestic property. Elevator systems in domestic settings may not include a hoistway or machine room, which are typical infrastructure features of large weight and occupant capacity elevator systems. Such smaller elevator systems may also have applicable uses in commercial environments.

Compared to their larger counterparts, such lower weight capacity elevator systems have additional operational requirements. For example, a hoistway-less elevator system must include additional safety systems to avoid damage to property and injury as a result of obstruction of the pathway of an elevator car of such a system (the physical barrier provided by a conventional hoistway not being present). In addition, such systems will often pass through fire-rated ceilings and/or floors (i.e. ceilings and/or floors designed to resist the spreading of fire) and the elevator systems will often need safety systems which maintain the ability of the ceiling and/or floor to act as a barrier against the spreading of fire.

There is also an increasing need for lower weight capacity elevator systems to serve more levels (i.e. more than just two levels). Such elevator systems typically traverse between different rooms in domestic living spaces. There is a need for such elevator systems to reduce noise, wind and drafts and maintain fire safety and physical safety regulations by providing adequate separation between different rooms in the domestic setting. Therefore, it is typically necessary to provide a plate over any apertures in the floors of the building through which the elevator car passes. Such a plate serves to cover the aperture and aids in controlling the spread of fire between levels of the building, reducing drafts between levels of the building, and reducing the risk of people, animals, and/or objects falling through the aperture.

The plate covers the aperture when the elevator car is beneath the aperture, but is then carried by the top of the elevator car as the elevator car passes through the aperture (the plate typically resting on top of the elevator car. As the elevator car returns downward through the aperture, the plate may be repositioned to cover the aperture.

The plate will, therefore, be larger than the aperture across a width thereof and smaller than a width of the elevator car (so that the elevator car may pass through the aperture but the plate is retained to cover the aperture, as the elevator car moves downward through the aperture).

The plate may, therefore, when in position covering the aperture, provide a surface on which objects, animals, or people may be located. A safety problem, accordingly, ensues if the elevator car is to rise through the aperture with an object, animal, or person located on the plate—as the plate will move upward carried by the elevator car as it rises through the aperture.

Many of these issues do not arise in relation to elevator systems with a hoistway or which are in industrial or construction environments (in which there is often other safety equipment, such as cages, present to reduce the risk of some of these problems but which would be unsightly in a domestic setting).

Some important developments in hoistway-less elevator systems are described in WO2020089606, the contents of which are incorporated herein in their entirety.

Versions of the present technology seek to alleviate one or more problems associated with the prior art.

### SUMMARY

An aspect provides an elevator plate assembly for use with an elevator system including an elevator car configured to move between levels of a building along a pathway, the assembly including: a plate configured to be positioned to cover an aperture defined by a floor of the building and to be carried by the elevator car as the elevator car travels along the pathway through the aperture defined by the floor of the building; and a sensor system configured to be communicatively coupled to a control system of the elevator system, the sensor system including a pressure sensitive device coupled to the plate, the pressure sensitive device being configured to detect the presence on an obstruction on the plate by detecting a force applied to the pressure sensitive device which is greater than a threshold force, such that, on detection of the presence of an obstruction by the pressure sensitive device, the sensor system is configured to send an alert to the elevator control system.

The pressure sensitive device may include a first electrically conductive layer and a second electrically conductive layer separated by an electrically insulative layer through which may be defined one or more cavities, such that the force applied to the pressure sensitive device presses the two electrically conductive layers together through at least one of the one or more cavities.

The first electrically conductive layer may be formed from an electrically conductive textile.

The electrically insulative layer may be formed from a foamed material.

The electrically insulative layer may define a plurality of cavities which may be evenly distributed throughout the electrically insulative layer.

The electrically insulative layer may define a plurality of cavities and the cavities may be distributed such that there are more in one part of the electrically insulative layer compared to another.

The pressure sensitive device may include a cover which envelopes the first electrically conductive layer, the second electrically conductive layer, and the electrically insulative layer.

The pressure sensitive device may have a sensing area over which forces are sensed and the sensing area may cover more than 50% of a top surface of the plate.

The sensor system may be configured to communicate with an elevator control system using a wireless communication link.

The sensor system may be configured to communicate with an elevator control system using a wired communication link.

The sensor system may further include a battery configured to power operation of the sensor system.

Another aspect provides an elevator plate assembly for use with an elevator system including an elevator car configured to move between levels of a building along a pathway, the assembly including: a plate configured to be positioned to cover an aperture defined by a floor of the building and to be carried by the elevator car as the elevator car travels along the pathway through the aperture defined by the floor of the building; and a sensor system configured to be communicatively coupled to a control system of the elevator system, the sensor system including a camera positionable relative to the plate such that the plate is within a field of view of the camera, the camera being configured to detect the presence on an obstruction on the plate by analysing at least one image captured by the camera of the field of view, such that, on detection of the presence of an obstruction by the camera, the sensor system is configured to send an alert to the elevator control system.

The camera may be positioned above the plate.

The camera may be mounted to a channel member of the elevator system.

The camera may be mounted on the plate.

The camera may be a 3D camera.

Another aspect provide an elevator plate assembly for use with an elevator system including an elevator car configured to move between levels of a building along a pathway, the assembly including: a plate configured to be positioned to cover an aperture defined by a floor of the building and to be carried by the elevator car as the elevator car travels along the pathway through the aperture defined by the floor of the building; and a sensor system configured to be communicatively coupled to a control system of the elevator system, the sensor system including an active sensor positionable relative to the plate such that the plate is within a sensor zone of the active sensor, the active sensor being configured to detect the presence on an obstruction on the plate by analysing data captured by the active sensor of the sensing zone, such that, on detection of the presence of an obstruction by the active sensor, the sensor system is configured to send an alert to the elevator control system.

The active sensor may be a LIDAR sensor.

The active sensor may be an ultrasonic sensor.

The active sensor may be positioned above the plate.

### BRIEF DESCRIPTION OF THE DRAWINGS

In order that the present disclosure may be more readily understood, preferable embodiments thereof will now be described, by way of example only, with reference to the accompanying drawings, in which:

FIG. 1 shows part of an elevator system of some versions;

FIG. 2 shows a schematic view of an elevator system installed in a building according to some versions;

FIG. 3 shows a perspective view of a part of an elevator drive mechanism of some versions;

FIG. 4 shows a perspective view of a channel member of some versions;

FIG. 5 shows a perspective view of an elevator system with an elevator drive mechanism of some versions;

FIG. 6 shows an exploded perspective view of a pressure sensitive device of some versions;

FIG. 7 shows an exploded perspective view of a pressure sensitive device of some versions;

FIG. 8 shows a cross-section of a part of a pressure sensitive device of some versions;

FIG. 9 shows a cross-section through part of a floor of a building according to some versions;

FIG. 10 shows a cross-section through part of a floor of a building according to some versions; and

FIG. 11 shows a schematic view of a sensor system and elevator control system;

FIG. 12 shows a schematic view of an elevator plate assembly according to some versions showing that the sensor system and elevator plate are part of the assembly;

FIG. 13 shows the positioning of cameras and active sensors according to some versions; and

FIGS. 14 and 15 show a side view and a plan view of an elevator plate with a turret according to some versions.

### DETAILED DESCRIPTION

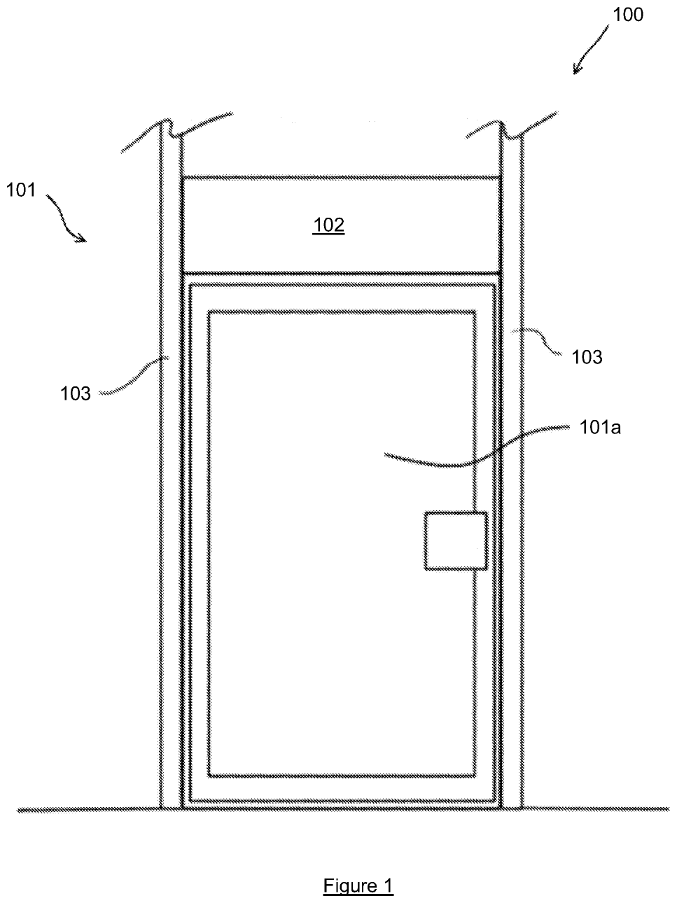

With reference to FIGS. 1-5, for example, some versions of the present technology include an elevator system 100 which may be a low capacity elevator system 100 which has a maximum load capacity of less than 350 kg or less than 300 kg or less than 200 kg, for example. The elevator system 100 may be configured for installation in a domestic application and may be configured to be retrofitted to an existing building (which may be a residence, for example). The elevator system 100 may be hoistway-less (in that the elevator system 100 includes no hoistway and needs no hoistway for its operation). The elevator system 100 may be located in domestic rooms, for example.

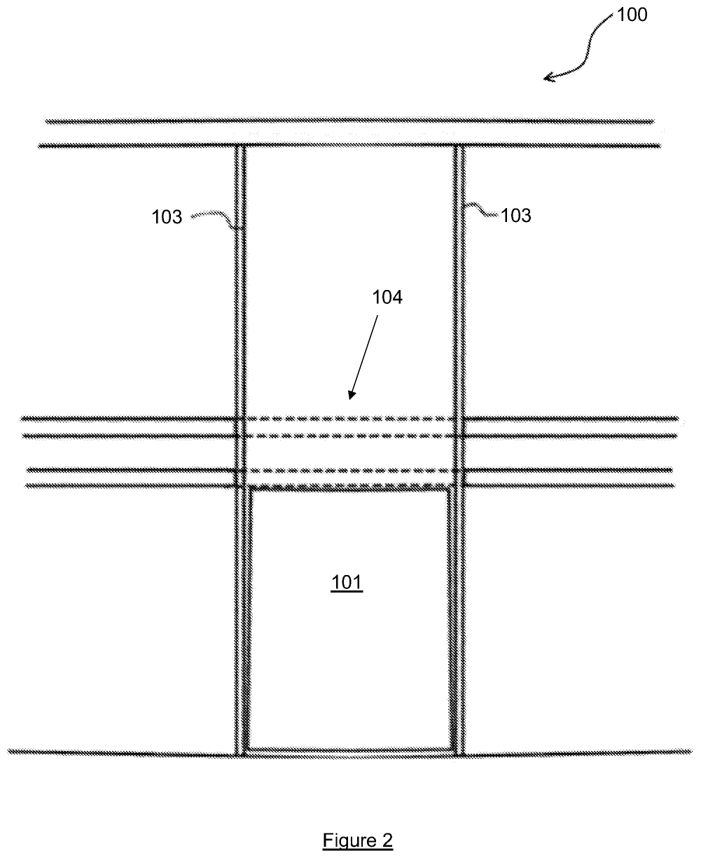

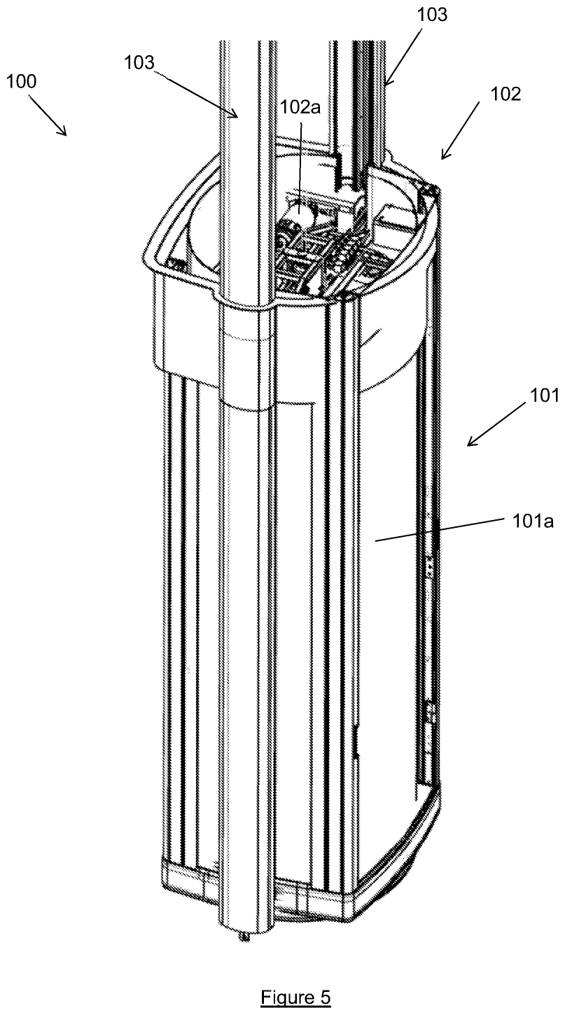

In some versions of the technology, the elevator system 100 includes an elevator car 101 which is configured to move between different levels of the building (as shown in FIG. 2 which shows two levels separated by a ceiling and floor) in relation to which the elevator system 100 is provided. The elevator car 101 may include a transportation compartment 101a (see FIG. 5 for example) which may be configured to carry one or more people or objects, for example. The transportation compartment 101a may be accessed through a door of the elevator car 101 and that door may be carried with the rest of the elevator car 101 as the elevator car 10 moves between levels of the building.

The elevator system 100 may include an elevator drive mechanism 102 (see FIGS. 1, 3, and 5, for example) which is configured to drive movement of the elevator car 101 between the different levels of the building (see FIG. 2 for example). The elevator drive mechanism 102 may be located above or below the transportation compartment 101a. The elevator drive mechanism 102 may be at least partially carried by the elevator car 101 and, in particular, the elevator car 101 may carry an elevator drive motor 102a of the elevator drive mechanism 102 (see FIGS. 1, 3 and 5, for example). The elevator drive motor 102a may be configured to drive the movement of the elevator car 101 and, so, the operation of the elevator drive mechanism 102.

The elevator drive mechanism 102 could take a number of different forms. In some examples, the elevator drive mechanism 102 may be a cable-drive system although the versions of the technology described may be used with other forms of drive system. The elevator drive mechanism 102 may be, for example, similar to that taught by AU2005200669. However, the majority of versions of the present technology will be described with reference to a rail or rack-and-pinion drive system. It will be appreciated, however, that some aspects of what is described will be equally applicable to other drive systems (such as cable-drive systems) and are not limited to their use in rail or rack-and-pinion drive systems.

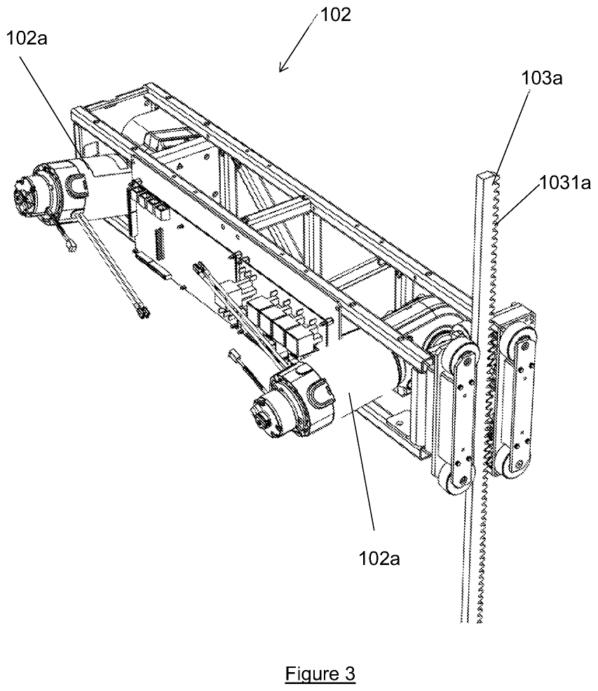

With this in mind, in some versions, the elevator drive mechanism 102 may be a rail drive system. As used herein, a rail drive system is intended to encompass elevator drive mechanisms 102 in which the elevator drive mechanism 102 moves along a rail 103a (e.g. a rigid rail 103a) and the movement is driven by an engagement of the elevator drive mechanism 102 and the rail 103a—see FIG. 3, for example. An example of a rail drive system is, therefore, a rack-and-pinion drive system. However, instead of a rack 103a, a threaded elongate member may be provided and the pinion may be replaced by a correspondingly threaded member secured to the threaded elongate member for movement along a length thereof by rotation of the threaded elongate member with respect to the correspondingly threaded member (or vice versa). Portions of the rail 103a may be seen in FIG. 3, for example. As used herein, the term rail 103a is intended to encompass a rack 103a.

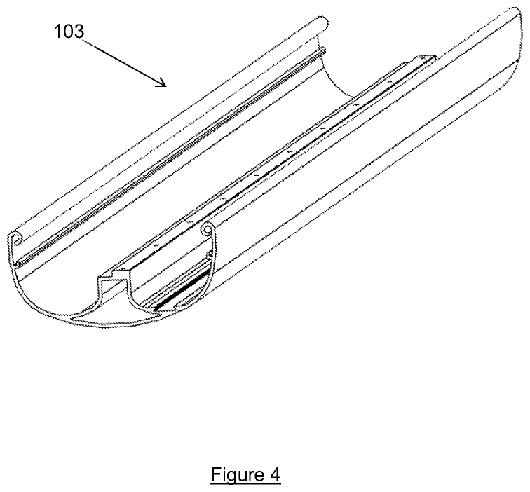

In some versions, the elevator system 100 may include one or more channel members 103 (which may be fitted to the building which the elevator system 100 serves)—see FIGS. 1, 2and 4, (with FIG. 4 showing a section of channel member 103 in isolation), for example. The one or more channel members 103 may be elongate channel members 103 which extend along the length of travel of the elevator car 101. The or each channel member 103 may be fixedly secured to the building and, for example, one or both ends of the or each channel member 103 may be secured to a floor or ceiling or joist or other part of the structure of the building. This may be achieved, for example, using one or more bolts (e.g. in a nut and bolt arrangement). In some versions, the or each channel member 103 is secured to the building at one or more respective locations along its length between the ends thereof and this may help to reduce vibration and noise.

The or each channel member 103 may have a generally c-shaped cross-section, and may have a generally E-shaped cross-section (e.g. a c-shaped cross-section with a protrusion between the two remote parts thereof)—see FIG. 4 for example. The or each channel member 103 may have a uniform cross-section along substantially all of its length and, in some versions, along the entire length. Accordingly, the protrusion may be an elongate protrusion running a or the length of the channel member 103 of which it is a part.

The rail 103a (which may be the rack 103a) may be located within the confines of a one of the or each channel member 103 and, in some versions, there may be multiple channel members 103 each with a respective rail 103a (e.g. a rack 103a) located therein. Accordingly, the channel member or members 103 may inhibit access to and/or cover at least part of the rail 103a (or rack 103a). In other words, from at least one side, the channel member or members 102 inhibit access to and/or sight of at least part of the rail 103a (or rack 103a)—this may be for safety and/or aesthetics.

The rail 103a (or rack 103a) may extend along a length of the channel member 103 in which it is located and may extend substantially along the entire length of the channel member 103 in which it is located. The same may be true of all rails 103a (or racks 103a) and their respective channel members 103 according to some versions.

The or each channel member 103 may extend generally in a direction of travel of the elevator car 101 of the elevator system 100. In some versions, the or each channel member 103 is a substantially vertical channel member 103.

The rail 103a (or rack 103a) may be mounted to the channel member 103 in which it is located and may extend parallel thereto. The rail 103a (or rack 103a) may be a substantially vertical rail 103a (or rack 103a).

The rail 103a (or rack 103a) may be secured to the channel member 103 in which it is located and/or may be secured in position relatively thereto. The rail 103a (or rack 103a) may be secured by the use of one or more bolts, for example, which pass through a part of the rail 103a (or rack 103a) and at least part (e.g. the protrusion) of the channel member 103 in which it is located. In some versions, the rail 103a (or rack 103a) may be adhered to the channel member 103 or welded thereto, for example. In some versions, the rail 103a (or rack 103a) includes one or more mounting brackets and the rail 103a (or rack 103a) is secured to the channel member 103 via the or each mounting bracket. In some versions, the rail 103a (or rack 103a) is secured to the building via one or both ends thereof and, in some such versions, may not be attached to the channel member 103 in which it is located.

In some versions, the rail 103a (or rack 103a) is provided in sections which have a shorter length than a length of the channel member 103 in which the rail 103a (or rack 103a) is located. Accordingly, it may be necessary to use a rail 103a (or rack 103a) which comprises a number of rail 103a (or rack 103a) sections aligned with each other in a linear manner.

In some versions, the rail 103a (or rack 103a) includes a plurality of teeth 1031a—see FIG. 3, for example. The teeth 1031amay be arranged to face the same direction along the length of the rail 103a (or rack 103a). This direction may be forwardly or backwardly or sideways inwardly or sideways outwardly, for example. In this sense, forwardly refers to a direction in which access to the transportation compartment 101a is provided, backwardly is a direction towards an opposing side of the transportation compartment 101a, sideways inwardly is a direction towards the elevator car 101 (or towards a first side of the elevator car 101 depending on the position of the rail 103a or rack 103a), and sideways outwardly is in a direction away from the elevator car 101 (or towards a second side of the elevator car 101 depending on the position of the rail 103a or rack 103a).

The channel member 103 may be formed from a metal, such as aluminium. The rail 103a (or rack 103a) may be formed from a metal, such as steel (which may be stainless steel or not). In some versions, the channel member 103 may be formed from a plastics material.

In some versions, the channel member 103 and the rail 103a (or rack 103a) are integrally formed.

In some versions, see FIG. 3for example, the rail 103a or rack 103a is a rack 103a which generally comprises an elongate member with a generally rectangular cross-section and teeth 1031a provided on a shorter surface thereof. The teeth 1031a may be provided generally perpendicular to the direction of extension of the elongate rack 103a. In some versions, the teeth are angled with respect to this perpendicular direction (e.g. inclined or declined).

In some versions, the rail 103a or rack 103a is in the form of a rail 103a. In some such versions the rail 103a may include an elongate member with a generally circular cross-section. Teeth 1031a may be provided facing one direction and those teeth may extend through 180 degrees or less of the circumference of the cross-section of the rail 103a. The teeth 1031a may be provided generally perpendicular to the direction of extension of the elongate rail 103a. In some versions, the teeth are angled with respect to this perpendicular direction (e.g. inclined or declined).

In some versions, the or each channel member 103 extends through the entire length (i.e. height) which the elevator car 101 is to travel. In some embodiments the or each channel member 103 extends through each level which the elevator system 100 is configured to serve (i.e. to which the elevator system 100 is configured to deliver the elevator car 101) from the floor of each level to the ceiling of each level. This need not be the case, however, in relation to the uppermost level which the elevator system 100 is configured to serve—at which the or each channel member 103 may be configured to extend a part of the length/height of that level. The or each channel member 103 may extend also through any horizontal partition between levels (e.g. a ceiling and/or floor). In some versions, due to the position of the elevator drive mechanism 102 (e.g. above the transportation compartment 101a) a full range of movement of the elevator car 102 relative to the channel member(s) 103 (and so the building) may be achieved without the or each rail 103a (or rack 103a) extending through a lowermost portion of its associated channel member 103.

In some versions, there is one single (i.e. one and only one) channel member 103 housing one rack 103a and the elevator car 101 may be cantilevered with respect thereto. In some versions, however, there is more than one channel member 103. In some embodiments, a first channel member 103 may be provided on the first side of the elevator car 101 and a second channel member 103 may be provided on the second side of the elevator car 101 (the first and second sides of the elevator car generally opposing each other). Accordingly, the first and second channel members 103 may be provided across a width of the elevator system 100. In some versions, one or more further channel members 103 may be provided (and the one or more further channel members 103 may or may not include a rail 103a or rack 103a).

In some versions, there is more than one channel member 103 (e.g. two-see FIG. 2 or 4) and at least two channel members 103 each include a respective rail 103a (or rack 103a). In some versions, there are three channel members 103 which each may include a respective rail 103a (or rack 103a) and, in some versions, there are four channel members 103 which each include a respective rail 103a (or rack 103a). The channel members 103 may be provided in pairs on opposing sides or parts of the elevator car 101 or elevator system 100. In some versions, other distributions of channel members 103 around the elevator car 101 or elevator system 100 may be provided.

As described herein, the elevator car 101 may be carried between levels of the building using the or each rail 103a (or rack 103a). To this end, the elevator drive mechanism 102 may be configured to drive movement of the elevator car 101 along the or each rail 103a (or rack 103a) and the or each rail 103a (or rack 103a) may be provided in the building extending between the levels which are to be serviced by the elevator system 100.

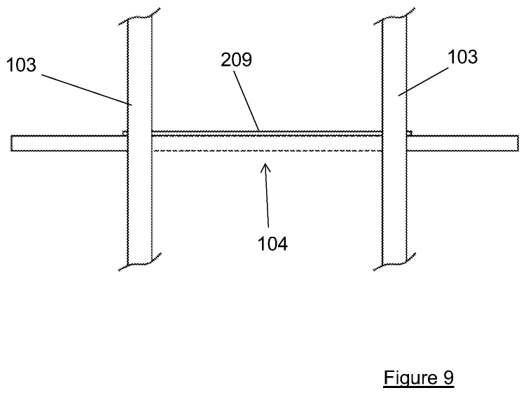

The pathway of the elevator car 101 may, therefore, be through one or more floors and/or ceilings of the building. The or each rail 103a (and/or channel member 103) may also, as such, extend through the or each floor and/or ceiling. Accordingly, the or each floor and/or ceiling may define a respective aperture 104 (see FIGS. 2 and 9, for example) through which the elevator car 101 is configured to pass. The pathway for the elevator car 101 may, accordingly, be through the or each such aperture 104. The or each channel member 103 and/or rail 103a may also extend through the or each aperture 104.

The elevator system 100 may be provided with an elevator plate 209 (see FIG. 9, for example). The elevator plate 209 is configured to cover such an aperture 104 when the elevator car 101 is beneath the aperture 104. The elevator plate 209 may be configured to cover the aperture 104 defined by a floor of the building. In some versions, the elevator plate 209 may form, therefore, a surface which is adjacent the floor of the building and, in some cases, a person, object, or animal travelling across that floor may pass over the elevator plate 209. In some versions, the elevator plate 209 is accessible from a room of the building such that one or more objects may be placed on top of the elevator plate 209, and/or a person or animal may step onto the elevator plate 209.

The aperture 104 defined by the floor of the building may be shaped so as to correspond with a shape of the elevator car 101 such that the elevator car 101 may pass through the aperture 104. The clearance between one or more (or all) external side surfaces of the elevator car 101 and the adjacent edges defining the aperture 104, with the elevator car 101 passing through the aperture 104, may be less than 15 cm or less than 10 cm or less than 5 cm.

The elevator plate 209 may be the same shape as the aperture 104. The elevator plate 104 may be larger than the aperture 104. In some versions, the elevator plate 209 is larger than the aperture 104 such that all of the aperture 104 is coverable by the elevator plate 209. In some versions, the elevator plate 209 is larger than the aperture 104 across at least one width of the elevator plate 209 and corresponding width of the aperture 104. Accordingly, with the elevator plate 209 parallel to a surface of the floor defining the aperture 104, the elevator plate 209 may not pass through the aperture 104 because the elevator plate 209 will abut the floor.

In some versions, there may be one or more parts of the aperture 104 which are not coverable by the elevator plate 209. In some versions, these one or more parts may be located adjacent a perimeter of the elevator plate 209 or may be by virtue of one or more holes defined by the elevator plate 209 itself. In some such versions, these one or more parts are relatively small (e.g. with no width greater than 10 cm, or greater than 5 cm, or greater than 2 cm). In some such versions, these one or more parts are relatively small (e.g. with a width less than 10 cm, or less than 5 cm, or less than 2 cm) but may be in the form of a slot with a length which is greater than 10 cm, for example. Whilst described and depicted as a plate without any holes therethrough, in some versions the elevator plate 209 may have one or more holes therethrough and may, indeed, be in the form of a grid or mesh (which may, in some versions, be covered in an intumescent coating, for example). This may help to reduce the weight of the elevator plate 209. In some versions, however, the elevator plate 209 is a plate without any holes.

In some versions, the elevator plate 209 may fit around the or each channel member 103. As such, in these versions, when the elevator plate 209 is described as covering the aperture 104, this may be covering of the parts of the aperture 104 excluding the parts thereof through which the or each channel member 103 extends (an potentially excluding any volume within the channel member 103 at the location of the aperture 104 (the channel member 103 may be U- or E-shaped, as described herein, and so there may be a volume within the channel member 103). In some versions, the or each rail 103a extends through the aperture 104 but the channel member(s) 103 do not (the channel member(s) may extend from floor to ceiling but may not, in some versions, pass between the ceiling and the floor immediately above that ceiling), in which case, the elevator plate 209 may fit around the or each rail 103a in the same manner as described in relation to the channel member(s) 103.

The elevator plate 209 serves to cover the aperture 104 defined by the floor of the building. This may help to reduce the risk of the passage of fire or air (e.g. drafts) between levels of the building, and/or reduce the risk of objects falling to a lower level of the building, and/or may be provided for aesthetic purposes.

The elevator plate 209 may be formed from a plastics material. The elevator plate 209 may include one or more reinforcement elements (such as metal or plastics material beams or ridges). The elevator plate 209 may be substantially flat or may be domed.

The elevator plate 209 may be configured to resist the passage of fire therethrough. The elevator plate 209 may be formed from a fire resistance material or coated in a fire resistance material. The elevator plate 209 may include a fire seal (such as an intumescent seal) around part thereof and that part may be a peripheral edge thereof and/or a part which abuts the floor of the building. The elevator plate 209 may be configured to hold the weight of a person. The elevator plate 209 may be configured to support a maximum weight of 150 kg or 200 kg or 250 kg or 300 kg.

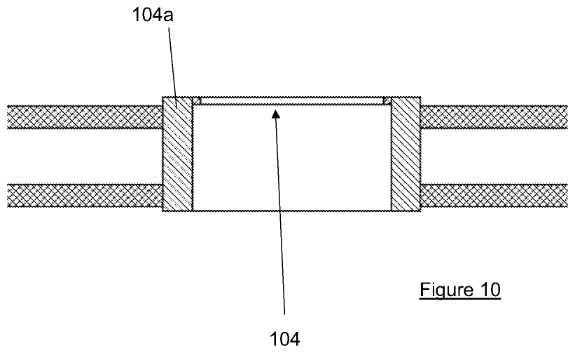

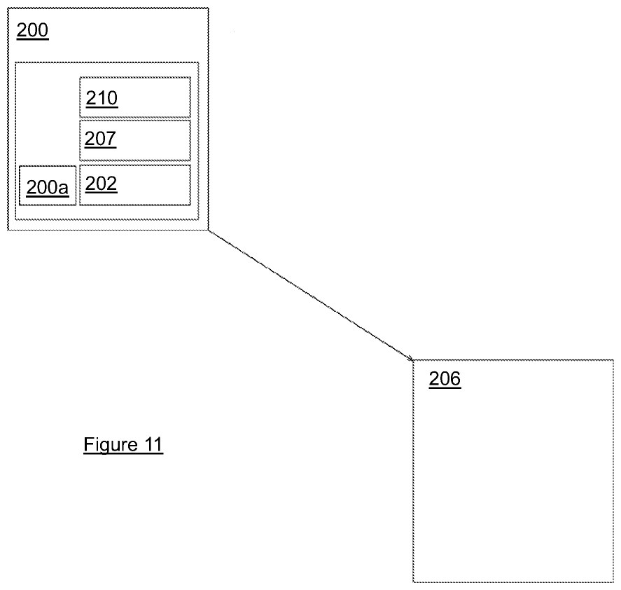

In some versions, there is a lining 104a provided (see FIG. 10 which shows a lining 104a within an aperture 104 defined by a floor and a ceiling, without the channel members 103 or rails 103a depicted for simplicity) which is located within a wider aperture defined by the floor and the lining 104a may define the aperture which is covered by the elevator plate 209 (e.g. with the elevator plate 209 being configured to abut part of the lining 104a). In such versions, the lining 104a may be considered to be part of the floor such that the aperture defined by the floor is, in fact, defined by the lining 104a of the floor. In some cases, the lining 104a may be conceptually viewed as part of the elevator system, however. References herein to abutment of the elevator plate 104 with the floor of the building should be construed as encompassing abutment with the lining 104a as well.

The elevator car 101 is configured to rise through the aperture 104 defined by the floor of the building. The elevator plate 209 may be configured to permit this to occur. As such the elevator plate 209 may be configured to move with respect to the floor and/or aperture as the elevator car 101 moves through the aperture 104.

In some versions, the elevator plate 209 is held in place covering the aperture 104 by gravity (lateral movement of the elevator plate 209 may be inhibited by the or each rail 103a and/or channel member 103 and/or one or more protrusions on an underside of the elevator plate 209 which are configured to abut edge surfaces defining the aperture 104 or adjacent thereto). As the elevator car 101 travels from beneath the elevator plate 209 up through the aperture 104, a top of the elevator car 101 may contact a part of the elevator plate 209 (e.g. an underside thereof). The elevator plate 209 may then be lifted away from the aperture 104 by the elevator car 101. In other words, the elevator plate 209 may be carried by the elevator car 101 as the elevator car 101 rises through the aperture 104. The elevator car 101 may engage the elevator plate 209 to move the elevator plate 209 along a vertical axis (i.e. along the pathway of the elevator car 101, which may be a vertical pathway).

Lateral movement of the elevator plate 209 with respect to the elevator car 101 may be inhibited by the or each rail 103a and/or channel member 103 and/or one or more protrusions on an underside of the elevator plate 209 which are configured to abut edge surfaces located in the top of the elevator car 101.

Accordingly, the elevator car 101 may rise through the aperture from a level beneath the floor to a level provided by the floor or above the floor (with the elevator plate 209 carried atop the elevator car 101).

In some versions, the elevator car 101 will then block or substantially block the aperture 104 to serve one or more of the same functions as the elevator plate 209 when it was covering the aperture 104. In some versions, the elevator car 101 may rise to yet another level and a system may be provided for a second elevator plate (not shown) to be left behind to cover at least part of the aperture 104 (e.g. from the bottom of the elevator car 101).

As the elevator car 101 travels downwards through the aperture 104, the elevator plate 209 may be retained, as described, by abutment with the floor so that the elevator plate 101 again covers the aperture 104.

As will be understood, therefore, the elevator car 101 may collect the elevator plate 209 during an upward movement of the elevator car 101 through the aperture 104 and may retain the elevator plate 209 (carrying the elevator plate 209 therewith). The elevator car 101 may then deposit or return the elevator plate 209 to a position which covers the aperture 104, as the elevator car 101 passes downwardly through the aperture 104.

The elevator system 100 may include an elevator sensor system 200 (which may be referred to herein as a sensor system 200).

The sensor system 200 may be configured to determine (e.g. sense) the presence of an object (which may include not only a non-human/animal object but which may include a human or animal, and should be construed accordingly when referenced herein) located on the elevator plate 209. This determination may be made when the elevator plate 209 is covering the aperture 104 (e.g. when the elevator plate 209 is not being carried by the elevator car 101). In some versions, the sensor system 200 is inoperative, or signals from the sensor system 200 are disregarded, when the elevator plate 209 is being carried by the elevator car 101 (which may be determined based on a location of the elevator car 101 as tracked by an elevator control system 206 using known tracking systems such as encoder wheels).

An object on the elevator plate 209 may be an obstacle to movement of the elevator car 101. The presence of an obstacle may, on continued movement of the elevator car 101 to carry the elevator plate 209, damage the elevator system 100 or parts thereof. Furthermore, the obstacle may be injured (if a person or animal) or damaged by movement of the elevator plate 209 relative to the floor of the building defining the aperture 104.

The elevator sensor system 200 may, therefore, be configured to determine the presence of an obstruction and send a corresponding signal to the elevator control system 206 (the elevator control system 206 being configured to control the operation of the elevator drive mechanism 102 to move the elevator car 101 between levels of the building). The elevator control system 206 may be configured to take action in response to receipt of such a signal and this may include one or more of stopping upward movement of the elevator car 101, commencing downward movement of the elevator car 101, slowing upward movement of the elevator car 101, or preventing new movement of the elevator car 101. In some versions, there is a signal provided to the elevator control system 206 when no obstacle is detected and that signal is stopped when an obstacle is detected, to the same effect—as will be appreciated the stopping of that signal is effectively a signal (or indication) sent to the elevator control system 206 of the presence of the obstacle. In some versions, the signal may also or alternatively trigger an audible or visual alert to a user in the elevator car 101 (e.g. providing an instruction to stop the movement of the elevator car 101 or information indicating that the elevator car 101 is taking action in response to a detected obstruction).

The elevator sensor system 200 may, therefore, include a processor. The elevator sensor system 200 may also include a non-transitory computer readable medium configured to store instructions for execution by the processor (those instructions determining the operation of the elevator sensor system 200 as described herein).

The elevator sensor system 200 may be configured to be positioned relative to the elevator plate 209 so as to enable the elevator sensor system 200 to sense the presence of an obstruction on the elevator plate 209. In some versions, therefore, the elevator sensor system 200 may be attached to and/or carried by the elevator plate 209. In some versions, at least part of the elevator sensor system 200 may be configured to be attached to another part of the elevator system 100, such as the elevator car 101, or positioned remotely from the elevator system 100 (such as on a ceiling or wall or floor of the building).

The sensor system 200 may be communicatively connected to the elevator control system 206. The sensor system 200 may be configured to be connected via a hardwire arrangement to the elevator control system 206. For example, the sensor system 200 may be configured to be connected to the elevator control system 206 by an electrical conductor provided in one or more of the one or more channel members 103 and/or rails 103a. In other versions, the sensor system 200 may be configured to be connected to the elevator control system 206 by a wireless communication channel which may be a Bluetooth or WiFi communication channel, for example.

In some versions, the elevator sensor system 200 may be or may include a pressure sensor system 200 configured to detect the presence of an obstacle on the elevator plate 209.

The pressure sensor system 200 may include a pressure sensitive device 202 which is configured to detect a force (e.g. the weight of an object) acting thereon. The pressure sensitive device 202 may be configured to detect a force acting thereon which is a downward force and/or which is greater than a threshold force.

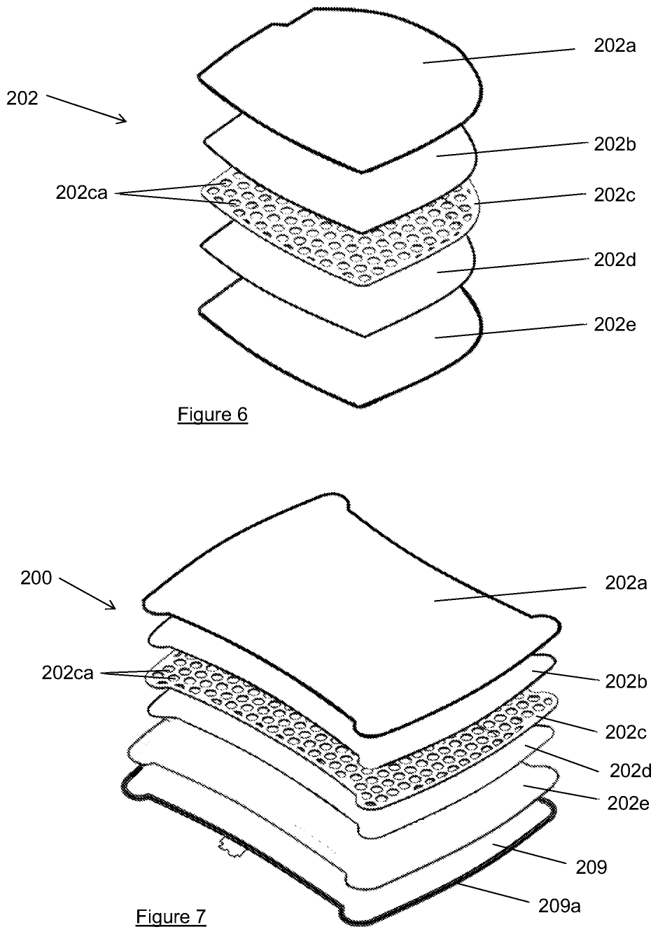

Accordingly, the pressure sensitive device 202, such as those shown in FIGS. 6 to 8 for example, may be in the form of a pad. The pressure sensitive device 202 may have a shape which corresponds with a shape of the elevator plate 209. The pressure sensitive device 202 may be the same shape as the elevator plate 209. The pressure sensitive device 202 may cover all or substantially all of the surface area of the elevator plate 209 and that surface area may be of an upper side of the elevator plate 209.

In some versions, there may be a peripheral gap between an outer edge of the elevator plate 209 and an outer edge of the pressure sensitive device 202. In some versions, that outer edge is a raised or bevelled edge 209a of the elevator plate 209—which may help to keep located and retain the pressure sensitive device 202.

The pressure sensitive device 202 may be attached to the elevator plate 209 using fixings, an adhesive or an adhesive tape, for example. The peripheral gap may permit one or more surface coverings to be secured over the pressure sensitive device 202—such as carpet. The one or more surface coverings may be provided for aesthetic reasons and/or to reduce wear on a surface of the pressure sensitive device 202. Accordingly, the or each surface covering may be secured to the elevator plate 209 (using the peripheral gap) rather than through the pressure sensitive device 202—this may be using fixings, an adhesive or an adhesive tape, for example.

The sensor system 200 may, therefore, include the pressure sensitive device 202 and this may be attached to, or otherwise provided on, the elevator plate 209. The pressure sensitive device 202 may be configured to detect the presence of an obstruction on the elevator plate 209 by detecting a force applied to the pressure sensitive device 202. As mentioned, the pressure sensitive device 202 may be configured to detect a force applied to the pressure sensitive device 202 greater than a threshold force. For example, the pressure sensitive device 202 may be calibrated such that the threshold force may be greater than the atmospheric force applied to the pressure sensitive device 202 by air and/or the weight of any other materials secured to the elevator plate 209 above the pressure sensitive device 202 (such as the aforementioned surface covering(s)).

The threshold force may be a force greater than, for example, 100 g or 200 g or 300 g or 1 kg or 5 kg or 10 kg. The threshold force may be set such that small objects (which are likely to be little risk if moved as a result of the lifting of the elevator panel 209 by the elevator car 101) are ignored. In some instances, the primary concern may be the risk to humans and, therefore, the threshold force may be set to 7 kg or greater.

A large object at least partially resting on the pressure sensitive device 202 will exert a force (at least by virtue of its weight) on the pressure sensitive device 202 which exceeds the threshold force. Such large objects are considered to be obstacles, so triggering the sending of the signal as described herein.

The pressure sensitive device 202 may take a number of different forms. Some possible forms of the pressure sensitive device 202 are now described in more detail.

In some versions (see FIGS. 6-8 for example), the pressure sensitive device 202 may include a first electrically conductive layer 202b and a second electrically conductive layer 202d. The first and second electrically conductive layers 202b,d may be separated from contact (when a force applied thereto is less than the threshold force) by an electrically insulative layer 202c. Therefore, the electrically insulative layer 202c may be sandwiched between the first and second electrically conductive layers 202b,d.

The first electrically conductive layer 202b may be formed from a flexible material and this may be an electrically conductive textile, for example. The second electrically conductive layer 202d may be made from a flexible material and this may be an electrically conductive textile, for example, but in some versions is made from a more rigid material than the first electrically conductive layer 202b. In particular, the second electrically conductive layer 202d may be located (when fitted) closer to the elevator plate 209 than the first conductive layer 202b such that flexing of the second conductive layer 202b may be limited due to the support provided by the elevator plate 209. In some versions, however, both electrically conductive layers 202b, d may be formed of the same material so that which side of the pressure sensitive device 202 faces the elevator plate 209 is not operationally important. The electrically conductive textile may be a woven metal material or may be a material which has been coated in an electrically conductive material, for example.

The electrically insulative layer 202c may be an elastically compressible layer. The electrically insulative layer 202c may be formed from a foamed material-such as a foamed plastics material. The foam may be an open or closed cell foam.

The electrically insulative layer 202c may include one or more cavities 202ca through an entire depth thereof such that, in some versions, a force applied to the first electrically conductive layer 202b adjacent one of the one or more cavities 202ca will move the first electrically conductive layer 202b into contact with the second electrically conductive layer 202d within the cavity 202ca.

In some versions, the or each cavity 202ca is an open cavity that contains only a gas such as air or another gas such as nitrogen. In some versions, the or each cavity 202ca may include an electrically conductive material such as a metal pad to reduce the effective distance between the two electrically conductive layers 202b,d (i.e. the distance the conductive layers 202b,d need to move towards each other to allow electrical communication therebetween). In some versions, some cavities 202ca may include such electrically conductive material and some may not, or the volume of such material in respective ones of the cavities 202ca may be different.

In some versions, there may be many such cavities 202ca provided and these may be distributed evenly across the electrically insulative layer 202c. In some versions, there may be more cavities 202ca provided in one or more particular parts of the electrically insulative layer 202c.

In some versions, the size of the cavities 202ca may be uniform across the electrically insulative layer 202c and in some versions the size of the cavities 202ca may vary across the electrically insulative layer 202c.

The cavities 202ca may be circular. The cavities 202c may mean that the electrically insulative layer 202c has a honeycomb structure. In some versions a periphery of the electrically insulative layer 202c (e.g. a margin around the edge which is 1 cm wide or 2 cm wide) does not have any cavities 202ca and this may improve the durability of the electrically insulative layer 202c.

Accordingly, in some versions the threshold force is generally the same across the electrically insulative layer 202c but in some versions the threshold force varies (e.g. in accordance with the distribution of the cavities 202ca and/or the size distribution of the cavities 202ca and/or the provision of electrically conductive material within the cavities 202ca) across the electrically insulative layer 202c.

The threshold force may be determined, therefore, by one or more of the choice of material as the electrically insulative layer 202c, the size of the cavities 202ca, the number of the cavities 202ca, the use of electrically conductive material within the cavities 202ca (including the volume of such material), and the like.

Contact between the two electrically conductive layers 202b,d may, for example, complete an electrical circuit of the sensor system 200 and so cause the sensor system 200 to send a signal to the elevator control system 206, for example.

In some versions, contact between the two electrically conductive layers 202b,d is not required and the sensor system 200 may be configured to monitor a capacitance, for example, between the two electrically conductive layers 202b,d to determine when the electrically conductive layers 202b,d move closer together or further apart (such that when the two electrically conductive layers 202b,d move to within a predetermined distance of each other, a threshold force has been applied).

The pressure sensitive device 202 may be provided in the form of a pad (e.g. a device having a large length and width compared to its depth).

The first and/or second electrically conductive layers 202b,d may, therefore, be provided as sheets (with a larger length and width compared to their respective depths). The electrically insulative layer 202c may also be a sheet of material (with a larger length and width compared to its depth). The size (length and/or width) of each of the first and second electrically conductive layers 202b,d and the electrically insulative layer 202c may be generally the same as each other. In some versions, the electrically insulative layer 202c may have a larger width and/or length than the first and/or second electrically conductive layer 202b, d to reduce the risk of the two layers 202b,202d contacting each other around a periphery thereof.

Two wires or other conductors 204,205 may be provided, each in electrical communication with one of the electrically conductive layers 202b,d, to connect the pressure sensitive device 202 electrically to a circuit of the sensor system 200.

The first and second electrically conductive layers 202b,d and the electrically insulative layer 202c may be enveloped within a cover 202a,202e. The cover 202a,202e may be formed from first 202a and second 202e cover layers which may be located adjacent the first 202b and second 202d electrically conductive layers respectively. A width and length of the cover layers 202a,202e may be greater than the length and width of the electrically conductive layers 202b,d and electrically insulative layer 202c. A periphery of the cover layers 202a, e may be joined together (e.g. by RF welding or another technique). The two wires or other conductors 204,205 may extend through holes in the cover 202a,202e. The cover 202a202e may help to protect the rest of the pressure sensitive device 202 (e.g. the first and second electrically conductive layers 202b,d and the electrically insulative layer 202c) from damage and may be used to help retain the relative positions of the first and second electrically conductive layers 202b,d and the electrically insulative layer 202c with respect to each other. The cover 202a,202d may be formed from a flexible material and that material may be a plastics material or rubber or rubber-like material, for example. The cover 202a,202d may be formed from an electrically insulating material.

Accordingly, the pressure sensitive device 202 may cover all or part of the elevator plate 209 and may be configured to detect an obstruction by virtue of a force applied thereto.

The sensor system 200 may include, as mentioned, circuitry connected to the pressure sensitive device 202 to detect when the force applied thereto exceeds the threshold force. That circuit may be powered by a battery 200a which may be provided as part of the sensor system 200 and which may be attached to the elevator plate 209 (in some cases beneath the elevator plate 209). In some versions, mains electrical power is provided and this may be delivered to the sensor system 200 via the or each channel member 103 (e.g. using carbon brushes contacting electrical conductors secured to the channel member 103).

Versions of the present technology may provide greater sensitivity to obstructions and/or more area of sensitivity than some other solutions.

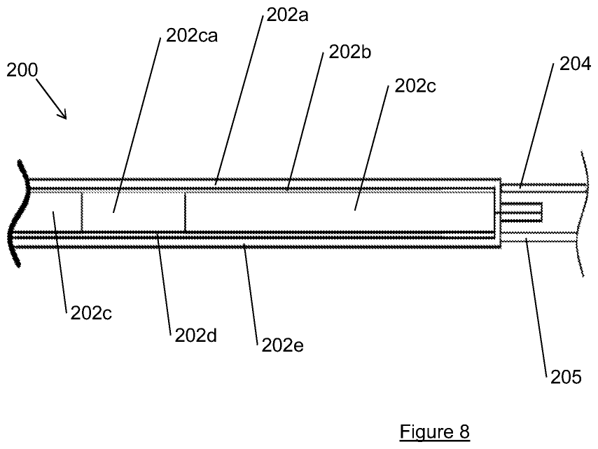

As described, different elevator systems 100 may include elevator plates 209 of different shapes and two example shapes are shown in FIGS. 6 and 7, for example. In some versions, the pressure sensitive device 202 may have a sensing area defined by the device 202 (e.g. by the electrically conductive layers 202b,d) over which forces can be sensed. The sensing area may be more than 25% of the surface area of a top surface of the elevator plate 209. The sensing area may be more than 50% of the surface area of a top surface of the elevator plate 209. The sensing area may be more than 75% of the surface area of a top surface of the elevator plate 209. The sensing area may be more than 85% of the surface area of a top surface of the elevator plate 209. The sensing area may be more than 95% of the surface area of a top surface of the elevator plate 209.

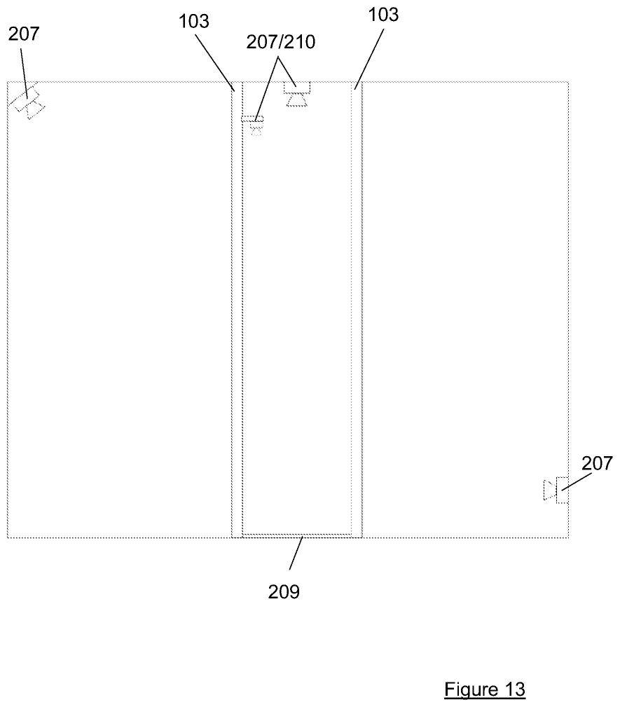

In some versions, the sensor system 200 may include a camera 207 (see FIG. 13) configured to detect the presence of an object on the elevator plate 209. The camera 207 may be configured such that a field of view of the camera 207 is positionable to capture a surface (e.g. an upper surface) of the elevator plate 209 (and/or the pressure sensitive device 202 and/or any surface covering, if provided).

The camera 207 may be configured to capture or analyse still or video images captured at predetermined intervals or continuously (e.g. once a second or faster) or in response to a predetermined event. The predetermined interval for the capturing and analysing may be altered according to usage requirements and processing requirements of the sensor system 200 and the elevator control system 206. In some versions, the camera 207 is configured to capture and analyse images only when the elevator car 101 is moving upward. In some versions, the camera 207 is configured to capture and analyse images only when the elevator car 101 is moving upward and is beneath the aperture covered by the elevator plate 209. The predetermined event may be a user making a request of the elevator control system 206 (e.g. using a user interface panel of the elevator system 100 or car 101) to move the elevator car 101. This may be any movement or any upward movement, for example (e.g. to a level above the current level). Indeed, in versions using the pressure sensitive device 202, the pressure sensitive device 202 may be checked only when such a predetermined event occurs (and/or at predetermined intervals, or continuously).

The camera 207 may be configured to detect the presence of an object on the elevator plate 209 by, for example, comparing the image to an image without an object present. In some versions, the camera 207 may be configured to perform object detection (e.g. using a YOLO architecture) or image segmentation (e.g. using a convolutional neural network).

In some versions, the camera 207 may be configured to identify the type of object (in addition to its presence) and determining what signal to send to the elevator control system 206 may depend on the type of detected object. In such versions, sensor system 200 may determine which control action the elevator system 100 should take (e.g. of those mentioned herein such as stopping or slowing the travel of the elevator car 101).

In some versions, the camera 207 may, therefore, include a processor and a non-transitory computer readable medium storing instructions which, when executed, perform the required steps.

As with other versions, the camera 207 may be wirelessly connected to the elevator control system 206 or may be connected through a hardwired communication link—see the description hereinelsewhere which applies equally here.

The camera 207 may be mounted directly above the elevator plate 209 (e.g. to a ceiling). The camera 207 may be wall mounted to a side of the elevator plate 209 (e.g. to a wall). The camera 207 may be mounted above and to a side of the elevator plate 209. The camera 207 may be located on (e.g. attached to) one of the channel members 103. These options are schematically shown in FIG. 13. In some cases, the field of view of the camera 207 is restricted to the elevator plate 209. In some cases, the edge of the elevator plate 209 is detected (and, indeed, may be of a particular colour to aid in this identification).

In some versions, multiple cameras 207 may be provided in case the view from one camera 207 is obstructed.

The or each camera 207 may be a visible light camera. In some versions, one or more of the cameras 207 may be a 3D camera, such that a height of an object on the elevator plate 209 may be determined using the camera 207. In some versions, instead of or in addition to one or more of the cameras 207, an active sensor 210 may be provided. Examples of an active sensor 210 include a ranging sensor 210 such as a LIDAR or ultrasonic ranging sensor may be used (or other laser or sonar based sensor). Other examples include emitter and receiver pairs which are spaced apart and configured to communicate through a sensing zone (e.g. across the elevator plate 209 and/or from a remote location (such as the ceiling) to the elevator plate 209). The presence of an object in the sensing zone may disrupt that communication and so indicate the presence of the object. The emitter and receiver pair may be laser-based and/or infrared-based, for example. The active sensor 210 and/or camera 207 are examples of non-contact sensors.

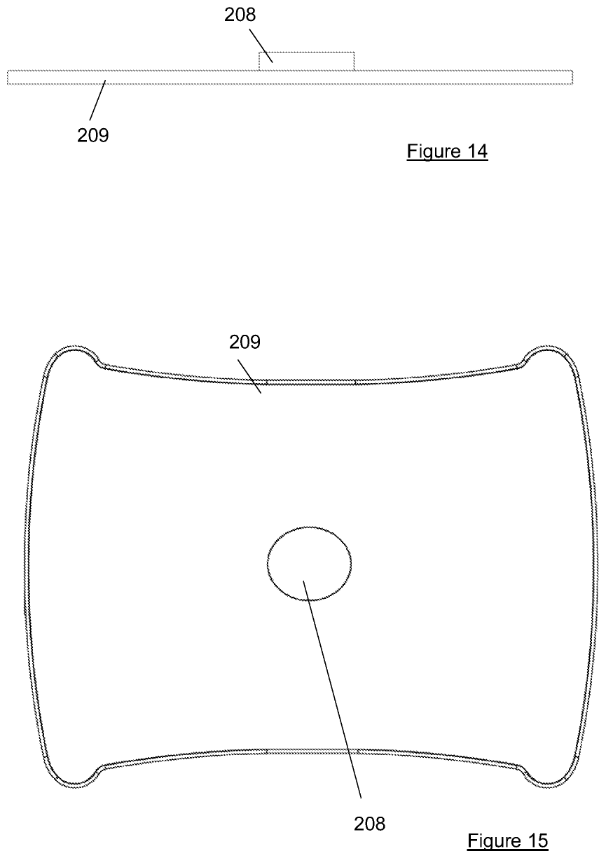

In some versions, the or each camera 207 and/or active sensors 210 may be mounted to the elevator plate 209. In such versions, there may be a turret 208 provided (see FIGS. 14 and 15, for example) which is mounted to the elevator plate 209. The turret 208 may rise above a main upper surface of the elevator plate 209 to provide the or each camera 207 and/or active sensor 210 (which may be mounted to or in the turret 208) a field of view covering all or part of the elevator plate 209. The turret 208 may be fixed or may be retractable, such that the turret 208 may move to an extended (e.g. sensing) position when the sensor(s) therein are required to sense whether there is an obstruction and may retract to a retracted (e.g. stowed) position when sensing is not needed. In the retracted position, a top of the turret 208 may be aligned with a top surface of the elevator plate 209. In some versions, there may be multiple cameras 207 and/or active sensors 210 to provide 360 degrees of coverage around the turret 208. In some versions, for example, the turret 208 may include a conical mirror (oriented with the point facing downwardly) with a camera 207 located beneath the conical mirror, and configured to capture and image reflected by the conical mirror—to provide 360 degrees of coverage.

Accordingly, the or each camera 207 and/or active sensor 210 may be positioned relative to the elevator plate 207 such that the elevator plate 207 is within a field of view thereof. Analysis of the captured image(s) and/or depth information may enable the camera 207 and/or active sensor 210 to determine whether there is an object on the elevator plate 209 and to send a signal to the elevator control system 206 accordingly. A signal may be sent indicating an obstruction based on, for example, the size of the detected object-such that an object greater than 5 cm or 10 cm or 20 cm or 30 cm in any dimension may be determined to be an obstruction. In the case of an active sensor 210, the field of view of the sensor may be referred to as a sensing zone of the sensor, for example. The active sensor may be configured to generate sensor data regarding the presence of objects (or not) in the sensing zone.

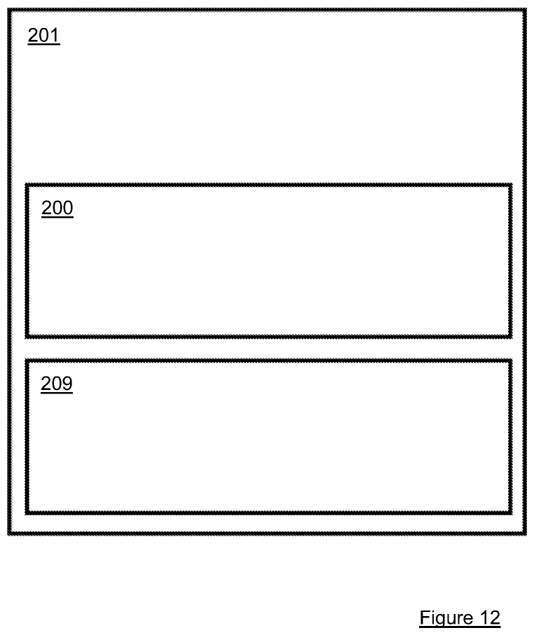

As will be appreciated, the elevator plate 209 may be fitted with the sensor system 200 and this may be collectively referred to as an elevator plate assembly 210 (see FIG. 12, for example). The elevator plate assembly may be fitted to, and may then form part of, the elevator system 100.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

What is claimed is:

1. An elevator plate assembly for use with an elevator system including an elevator car configured to move between levels of a building along a pathway, the assembly including:
a plate configured to be positioned to cover an aperture defined by a floor of the building and to be carried by the elevator car as the elevator car travels along the pathway through the aperture defined by the floor of the building; and
a sensor system configured to be communicatively coupled to a control system of the elevator system, the sensor system including a pressure sensitive device coupled to the plate, the pressure sensitive device being configured to detect the presence on an obstruction on the plate by detecting a force applied to the pressure sensitive device which is greater than a threshold force, such that, on detection of the presence of an obstruction by the pressure sensitive device, the sensor system is configured to send an alert to the elevator control system.

2. The assembly of claim 1, wherein the pressure sensitive device includes a first electrically conductive layer and a second electrically conductive layer separated by an electrically insulative layer through which are defined one or more cavities, such that the force applied to the pressure sensitive device presses the two electrically conductive layers together through at least one of the one or more cavities.

3. The assembly of claim 2, wherein the first electrically conductive layer is formed from an electrically conductive textile.

4. The assembly of claim 3, wherein the electrically insulative layer is formed from a foamed material.

5. The assembly of claim 2, wherein the electrically insulative layer defines a plurality of cavities which are evenly distributed throughout the electrically insulative layer.

6. The assembly of claim 2, wherein the electrically insulative layer defines a plurality of cavities and the cavities are distributed such that there are more in one part of the electrically insulative layer compared to another.

7. The assembly of claim 2, wherein the pressure sensitive device includes a cover which envelopes the first electrically conductive layer, the second electrically conductive layer, and the electrically insulative layer.

8. The assembly of claim 1, wherein the pressure sensitive device has a sensing area over which forces are sensed and the sensing area covers more than 50% of a top surface of the plate.

9. The assembly of claim 1, wherein the sensor system is configured to communicate with an elevator control system using a wireless communication link.

10. The assembly of claim 1, wherein the sensor system is configured to communicate with an elevator control system using a wired communication link.

11. The assembly of claim 1, wherein the sensor system further includes a battery configured to power operation of the sensor system.

12. An elevator plate assembly for use with an elevator system including an elevator car configured to move between levels of a building along a pathway, the assembly including:
a plate configured to be positioned to cover an aperture defined by a floor of the building and to be carried by the elevator car as the elevator car travels along the pathway through the aperture defined by the floor of the building; and
a sensor system configured to be communicatively coupled to a control system of the elevator system, the sensor system including a camera positionable relative to the plate such that the plate is within a field of view of the camera, the camera being configured to detect the presence on an obstruction on the plate by analysing at least one image captured by the camera of the field of view, such that, on detection of the presence of an obstruction by the camera, the sensor system is configured to send an alert to the elevator control system.

13. The assembly of claim 12, wherein the camera is positioned above the plate.

14. The assembly of claim 13, wherein the camera is mounted to a channel member of the elevator system.

15. The assembly of claim 12, wherein the camera is mounted on the plate.

16. The assembly of claim 12, wherein the camera is a 3D camera.

17. An elevator plate assembly for use with an elevator system including an elevator car configured to move between levels of a building along a pathway, the assembly including:
a plate configured to be positioned to cover an aperture defined by a floor of the building and to be carried by the elevator car as the elevator car travels along the pathway through the aperture defined by the floor of the building; and
a sensor system configured to be communicatively coupled to a control system of the elevator system, the sensor system including an active sensor positionable relative to the plate such that the plate is within a sensor zone of the active sensor, the active sensor being configured to detect the presence on an obstruction on the plate by analysing data captured by the active sensor of the sensing zone, such that, on detection of the presence of an obstruction by the active sensor, the sensor system is configured to send an alert to the elevator control system.

18. The assembly of claim 17, wherein the active sensor is a LIDAR sensor.

19. The assembly of claim 17, wherein the active sensor is an ultrasonic sensor.

20. The assembly of claim 17, wherein the active sensor is positioned above the plate.
